(19) United States
(12) Patent Application Publication
(10) Pub. No.: US 2009/0200503 A1
(43) Pub. Date: Aug. 13, 2009

(54) SOLENOID VALVE ASSEMBLY OF VARIABLE DAMPING FORCE DAMPER AND METHOD OF ASSEMBLING THE SAME

(75) Inventor: Kyu Shik Park, Seoul (KR)

Correspondence Address: SEED INTELLECTUAL PROPERTY LAW GROUP PLLC, 701 FIFTH AVE, SUITE 5400, SEATTLE, WA, 98104, US

(73) Assignee: MANDO CORPORATION, Pyeongtaek-si (KR)

(21) Appl. No.: 12/371,179

(22) Filed: Feb. 13, 2009

(30) Foreign Application Priority Data
Feb. 13, 2008 (KR) 10-2008-0012888

(51) Int. Cl. F16K 31/02

(52) U.S. Cl. 251/129.15

(57) ABSTRACT

A solenoid valve assembly of a variable damping force damper and a method of assembling the same are disclosed. The method includes coupling a valve housing to one side of a damper, accommodating an embedded assembly within the valve housing, the embedded assembly including a variable fluid path component and a solenoid operator, disposing a bobbin housing such that an inner circumference of the bobbin housing partially overlaps an outer circumference of the valve housing, while adjusting orientation of a power line connected to a bobbin accommodated in the bobbin housing, and fastening the bobbin housing to the valve housing, with the orientation of the power line adjusted.

### BACKGROUND

1. Technical Field

The present disclosure relates to a solenoid valve assembly of a variable damping force damper and a method of assembling the same, and, more particularly, to technology capable of enhancing ease of assembly of a variable damping force damper.

2. Description of the Related Art

Generally, a vehicle is provided with a damper (or shock absorber) for absorbing and releasing impact or vibration transmitted from a road or a part of the vehicle during driving. A damping force of the damper affects both driving comfort and handling stability of the vehicle. For example, a low damping force of the damper enhances driving comfort but deteriorates the handling stability of the vehicle. For this reason, in the case of turning, accelerating, braking or high speed driving of the vehicle, it is necessary to improve the handling stability of the vehicle by increasing the damping force to suppress variation in posture of a vehicle body.

In recent years, a variable damping force damper including a solenoid valve assembly for varying a damping force has been developed to adjust damping force characteristics. The solenoid valve assembly is configured to change a fluid path, through which an operating fluid, i.e., oil, flows, in response to electric signals to increase or decrease resistance to the operating fluid, thereby adjusting the damping force.

Typically, the solenoid valve assembly includes a variable fluid path component which includes a plurality of valve sheets or spools constituting minute orifices or fluid paths, and a solenoid operator which is operated to change the fluid paths of the variable fluid path component. The solenoid operator is driven by a bobbin connected to a power line. The power line is provided to supply electric power to the bobbin and is drawn outside a housing of the solenoid valve assembly.

The applicant of the present invention suggested a technique for securing a constant orientation of the power line drawn outside the housing when connecting the solenoid valve assembly to one side of the damper. In this technique, after the orientation of the power line is previously secured, the solenoid valve assembly is attached to the damper by an irreversible method such as caulking/curling or the like. However, this technique deteriorates operability and causes product failure or unfavorable operation, which requires reassembly operation, thereby deteriorating economic feasibility.

To solve such problems, the applicant of the present disclosure also suggested a technique for securing orientation of the power line located in one of two housings of the solenoid valve assembly with additional components, that is, nuts, for coupling the housings. In this technique, however, the additional components cause a cost increase and a size increase of the solenoid valve, which results in an increase in weight thereof.

### BRIEF SUMMARY

One embodiment provides a solenoid valve assembly of a variable damping force damper, which is configured to permit a bobbin housing to be fastened to a valve housing in a simple and inexpensive manner, with orientation of a power line secured, after the valve housing is primarily secured to an embedded assembly, and a method of assembling the same.

In accordance with one aspect, a solenoid valve assembly of a variable damping force damper includes a valve housing securely connected to one side of a damper; an embedded assembly accommodated in the valve housing, and including a variable fluid path component and a solenoid operator; a bobbin housing accommodating a bobbin connected to a power line to drive the solenoid operator, the bobbin housing being disposed such that an inner circumference of the bobbin housing partially overlaps an outer circumference of the valve housing; and an exterior fastening part fastening the bobbin housing to the valve housing after orientation of the power line is adjusted.

The solenoid valve assembly may further include an interior fastening part which secures the embedded assembly to the valve housing, and the interior fastening part may include screws corresponding to each other and formed on the inner circumference of the valve housing and the outer circumference of the embedded assembly, respectively.

The exterior fastening part may include a protrusion and a groove respectively formed on the inner circumference of the valve housing and the outer circumference of the bobbin housing overlapping each other, and the protrusion and the groove may be formed thereon by compressing the outer circumference of the bobbin housing onto the inner circumference of the valve housing.

In accordance with another aspect, a method of assembling a solenoid valve of a variable damping force damper includes: securely connecting a valve housing to one side of a damper; accommodating an embedded assembly within the valve housing, the embedded assembly including a variable fluid path component and a solenoid operator; disposing a bobbin housing such that an inner circumference of the bobbin housing partially overlaps an outer circumference of the valve housing, while adjusting orientation of a power line connected to a bobbin accommodated in the bobbin housing; and fastening the bobbin housing to the valve housing, with the orientation of the power line adjusted.

The accommodating an embedded assembly may include fastening the embedded assembly and the valve housing with a screw, and the fastening the bobbin housing to the valve housing may include engaging a groove with a protrusion, the groove and the protrusion being formed on the outer circumference of the bobbin housing and the inner circumference of the valve housing by compressing the outer circumference of the bobbin housing onto the inner circumference of the valve housing.

According to one embodiment, the solenoid valve assembly allows orientation of a power line to be easily secured when securing the solenoid valve assembly to a damper, and allows partial assembly of the solenoid valve assembly to be very easily and simply carried out.

### BRIEF DESCRIPTION OF THE SEVERAL VIEWS OF THE DRAWINGS

FIG. 1 is a half sectional view of a variable damping force damper including a solenoid valve assembly according to one embodiment;

FIG. 2 is a cross-sectional view of the solenoid valve assembly of FIG. 1; and

FIGS. 3 to 6 are cross-sectional views of a solenoid valve according to one embodiment at different steps of a method of assembling the solenoid valve.

### DETAILED DESCRIPTION

Some embodiments will now be described in detail with reference to the accompanying drawings. The embodiments are given by way of illustration and example for full understanding by those skilled in the art. Hence, the present disclosure and claims that follow are not limited to these embodiments and can be realized in various forms. Further, for convenience of description, width, length, and thickness of components are not drawn to scale in the drawings. Like components are indicated by like reference numerals throughout the specification.

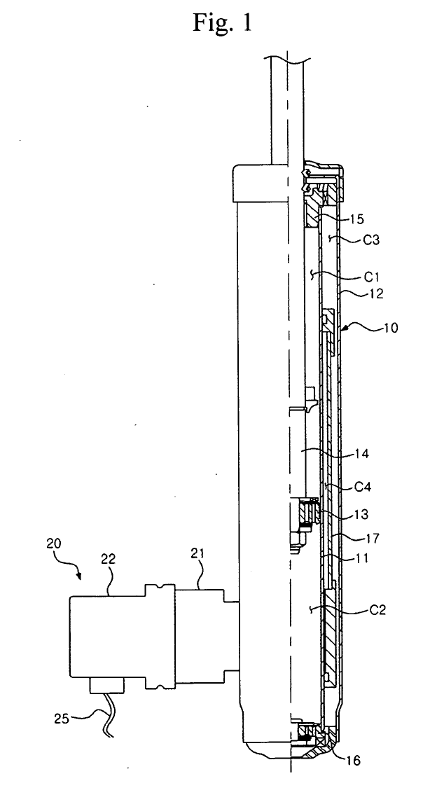

Referring to FIG. 1, which is a partial cross-sectional view of a variable damping force damper including a solenoid valve assembly according to one embodiment, the variable damping force damper includes a damper 10, and a solenoid valve assembly 20 secured to one side of the damper 10 and used for variable control of a damping force. The solenoid valve assembly 20 has an inlet and an outlet connected to high and low pressure sides of the damper 10 to receive an operating fluid from the high pressure side of the damper 10 through the inlet and to discharge the operating fluid to the low pressure side thereof through the outlet.

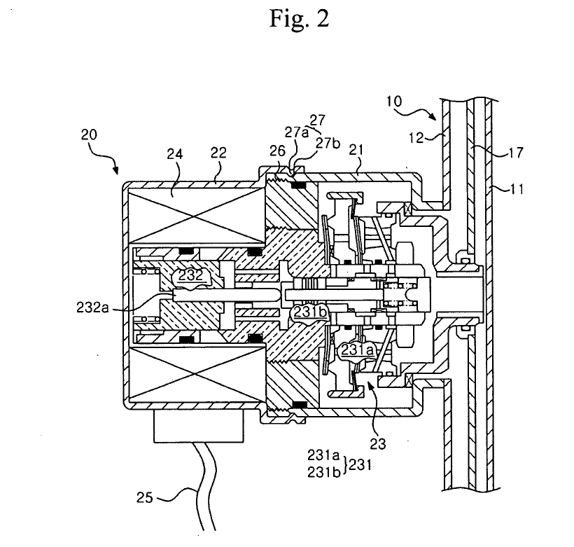

The solenoid valve assembly 20 changes resistance to the operating fluid therein by changing an internal fluid path of a variable fluid path component 231 (FIG. 2) based on a solenoid signal, thereby variably adjusting the damping force of the damper. Herein, the term “connected” includes the meaning that associated components are connected to allow the operating fluid to flow therethrough, therefore, being in fluid communication. Connected components can therefore be directly or indirectly physically coupled while being in fluid communication with each other.

The damper 10 includes an inner tube 11, an exterior tube 12 disposed outside the inner tube 11, a piston valve 13 received in the inner tube 11, and a piston rod 14 having one end connected to the piston valve 13. The piston rod 14 is slidably supported on a rod guide 15 which is positioned on upper ends of the inner tube 11 and the exterior tube 12.

The interior of the inner tube 11 is partitioned into an upper rebound chamber C1 and a lower compression chamber C2 by the piston valve 13. The piston valve 13 is configured to selectively permit flow of the operating fluid from the rebound chamber C1 to the compression chamber C2 or vice versa. The operating fluid generates a predetermined damping force by fluid passage resistance while flowing between the compression chamber C2 and the rebound chamber C1.

In order to compensate for variation in volume of the compression chamber C2, a reserve chamber C3 is provided between the inner tube 11 and the exterior tube 12 and is partially filled with the operating fluid, for example, oil. When the volume of the compression chamber C2 varies to cause pressure variation by movement of the piston valve 13, the operating fluid is supplied from the reserve chamber C3 to the compression chamber C2 or is withdrawn from the compression chamber C2 to the reserve chamber C3. Further, a body valve 16 is secured between the reserve chamber C3 and the compression chamber C2, particularly, to lower ends of the inner tube 11 and the exterior tube 12. The body valve 16 is also provided with a member that generates fluid path resistance to the flow of the operating fluid. Accordingly, a predetermined damping force is also generated by the flow of the operating fluid between the reserve chamber C3 and the compression chamber C2.

Further, an intermediate tube 17 is disposed between the inner tube 11 and the exterior tube 12 to define a high pressure chamber C4 along with the inner tube 11. Here, the high pressure chamber C4 communicates with the interior of the inner tube 11, that is, the rebound chamber C1 and/or the compression chamber C2, through, for example, an opening (not shown) formed in the inner tube 11.

The solenoid valve assembly 20 includes housings that accommodate an embedded assembly and a bobbin, one embodiment of which will be described below. The housings are constituted by a valve housing 21 and a bobbin housing 22 coupled to each other (see FIG. 2).

FIG. 2 illustrates a solenoid valve assembly according to one embodiment.

Referring to FIG. 2, the valve housing 21 is coupled at one side thereof to one side of the damper 10, and is coupled at the other side to the bobbin housing 22. Inside the valve housing 21 and the bobbin housing 22, which are coupled to each other, an embedded assembly 23 and a bobbin 24 are accommodated. Herein, the term “embedded assembly” includes an assembly of all components that can be accommodated in the housing in a state of being previously assembled, excluding the bobbin and other exterior components such as the valve housing and the bobbin housing.

The embedded assembly 23 includes a variable fluid path component 231 which supplies variable fluid paths, and a solenoid operator 232 which varies the fluid paths of the variable fluid path component 231. The variable fluid path component 231 includes a valve assembly 231a including a valve retainer, a valve disc, and the like, and a spool assembly 231b operated by the solenoid valve operator 232 to physically adjust a fluid path defined in the valve retainer. Further, the solenoid valve operator 232 includes a compression rod 232a that moves forward or backward by the bobbin 24 upon application of electric power to the bobbin 24 to forcibly move a spool of the aforementioned spool assembly 231b.

Further, when the embedded assembly 23 is accommodated in the valve housing 21, an outer circumference of the embedded assembly 23 is partially fastened to a part of an inner circumference of the valve housing 21. For this purpose, the solenoid valve assembly 20 includes an interior fastening part 26 that is constituted by a screw formed on an outer circumferential surface of the greatest diameter of the embedded assembly 23 and a screw formed on an inner circumferential surface of the valve housing 21 corresponding to the outer circumferential surface of the greatest diameter.

The embedded assembly 23 can be secured to the valve housing 21 by the interior fastening part 26. Here, since the respective screws constituting the interior fastening part 26 are integrally formed with a part of the outer circumference of the embedded assembly 23 and a part of the inner circumference of the valve housing 21, there is no need for separate components (such as nuts) for screw fastening.

On the other hand, the bobbin 24 is positioned around the solenoid operator 232 within the bobbin housing 22 to surround the solenoid operator 232. Further, the bobbin housing 22 includes a power line 25 that is connected to the bobbin 24 and is drawn outside the bobbin housing 22. Since the power line 25 is connected to an electronic control unit of a vehicle, orientation of the power line is previously determined during design of the vehicle.

The bobbin housing 22 is fastened to the valve housing 21 with the outer circumference of the valve housing 21 partially overlapping the inner circumference of the bobbin housing 22. Before being fastened to the valve housing 21, the bobbin housing 22 has a degree of freedom of rotation with respect to the valve housing 21 and the embedded assembly 23 disposed inside the valve housing 21. Thus, the power line 25 can be adjusted in a predetermined direction by rotating the valve housing 21. At this time, the portion of the outer circumference of the bobbin housing 22 overlapping the valve housing 21 has a greater diameter than the remaining portion of the bobbin housing 22, thereby forming a step on the inner circumference of the bobbin housing 22 such that the valve housing 21 can be seated on the step of the bobbin housing 22.

In one aspect, after the orientation of the power line 25 is adjusted, the valve housing 21 is coupled to the bobbin housing 22 by an exterior fastening part 27. In this embodiment, the exterior fastening part 27 is constituted by a ring-shaped protrusion 27a formed along the inner circumference of the bobbin housing 22 and a ring-shaped groove 27b formed along the outer circumference of the valve housing 21.

Since the embedded assembly 23 is firmly fastened to the valve housing 21, the exterior fastening part 27 is allowed to provide a low fastening force. It is advantageous for the exterior fastening part 27 to provide a low fastening force to allow easy separation of the valve housing 21 and the bobbin housing 22 from each other. In one aspect, the low fastening force of the exterior fastening part 27 facilitates selective separation of the valve housing 21 and the bobbin housing 22, therefore also facilitating repair, maintenance or management of the embedded assembly 23 through easy fastening and disconnection between the valve housing 21 and the bobbin housing 22 while providing sufficient force to maintain the valve housing 21 and bobbin housing 22 coupled during operation. Here, the protrusion 27a and the groove 27b of the exterior fastening part 27 may be formed by compressing the outer circumference of the bobbin housing 22 onto the inner circumference of the valve housing 21, which partially overlaps the outer circumference of the bobbin housing 22.

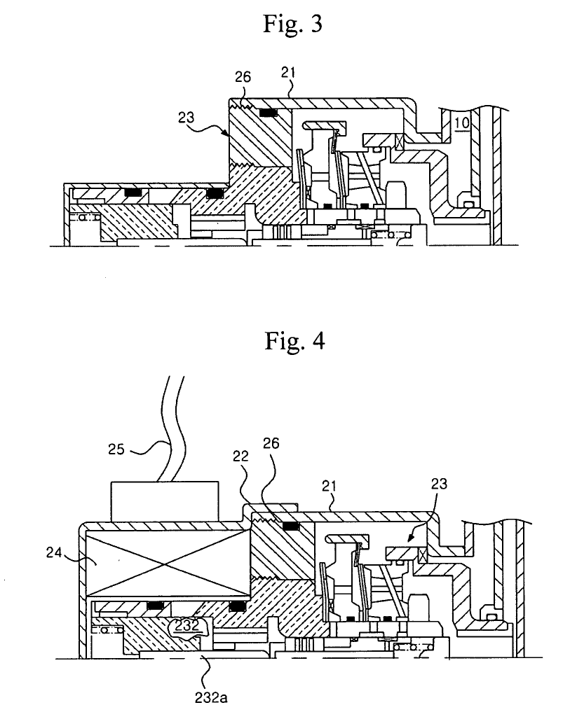

Next, a method of assembling the solenoid valve assembly according to one embodiment will be described with reference to cross-sectional views of FIGS. 3 to 6.

Referring to FIG. 3, the valve housing 21 is secured to one side of the damper 10. Then, the embedded assembly 23 is accommodated and fixed in the valve housing 21. Fixing the embedded assembly 23 with respect to the valve housing 21 is performed by threadedly fastening with an interior fastening part 26 that includes threads formed on the inner and outer circumferences of the valve housing 21 and the embedded assembly 23, respectively.

As shown in FIG. 4, the bobbin housing 22 is disposed such that the inner circumference of the bobbin housing 22 partially overlaps the outer circumference of the valve housing 21. The bobbin 24 is previously embedded in the bobbin housing 22, and the power line 25 connected to the bobbin 24 is drawn outside the bobbin housing 24. The disposition of the bobbin housing 22 is obtained by fitting the bobbin housing 22 into a portion of the outer circumference of the valve housing 21. Through this disposition, the solenoid operator 232 of the embedded assembly 23 is positioned at the center of the bobbin 24 inside the bobbin housing 22. The solenoid operator 232 includes a compression rod 232a that moves forward and rearward by a magnetic field generated upon application of electric power to the bobbin 24.

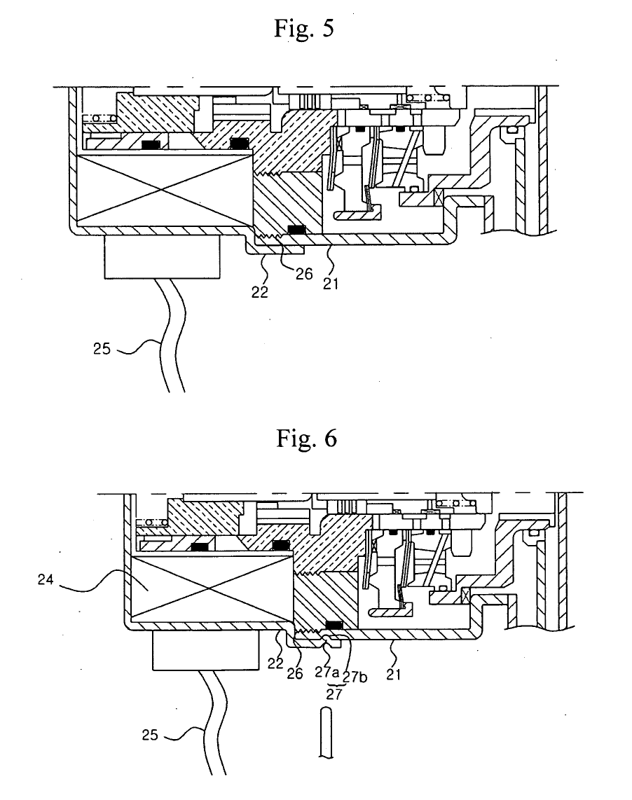

Next, as shown in FIG. 5, orientation of the power line 25 is adjusted. Since the bobbin housing 22 has a degree of freedom of rotation with respect to the valve housing 21 and the embedded assembly 23, the orientation of the power line 25 is adjusted by rotating the bobbin housing 21 at a predetermined angle. If the power line 25 is adjusted in a desired direction when fitting the bobbin housing 22 into the valve housing 21, it is possible to eliminate a separate operation for rotating the bobbin housing 22. In this case, it can be considered that the disposition of the bobbin housing 22 and the orientation adjustment of the power line 25 are simultaneously obtained.

Next, as shown in FIG. 6, the bobbin housing 22 and the valve housing 21 are securely fastened to each other. Here, the fastening is carried out by engagement between the protrusion 27a of the bobbin housing 22 and the groove 27b of the valve housing 21, which are formed by compressing the outer circumference of the bobbin housing 22 onto the inner circumference of the valve housing 21.

Although the present disclosure has been presented with reference to some embodiments, it should be noted that the scope of the present disclosure and the claims that follow is not limited to these embodiments, and that various modifications and changes can be made without departing from the spirit and scope of the present disclosure, as defined by the accompanying claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A solenoid valve assembly of a variable damping force damper, comprising:
a valve housing coupled to one side of a damper;
an embedded assembly accommodated in the valve housing, and including a variable fluid path component and a solenoid operator;
a bobbin configured to be connected to a power line to drive the solenoid operator;
a bobbin housing accommodating the bobbin, the bobbin housing being disposed such that an outer circumference of the valve housing partially overlaps an inner circumference of the bobbin housing defining an overlapping region; and
an exterior fastening feature formed at least between the valve housing and the bobbin housing, the bobbin housing being configured to be selectively removably coupled to the valve housing by the fastening feature, after orientation of the power line is adjusted.

2. The solenoid valve assembly according to claim 1, further comprising:
an interior fastening feature coupling the embedded assembly to the valve housing, the interior fastening feature including corresponding threads formed on the inner circumference of the valve housing and the outer circumference of the embedded assembly, respectively.

3. The solenoid valve assembly according to claim 1 wherein the exterior fastening feature includes a protrusion and a groove respectively formed on the inner circumference of the valve housing and the outer circumference of the bobbin housing adjacent the overlapping region.

4. The solenoid valve assembly of claim 3 wherein the protrusion and the groove are formed on the inner circumference of the valve housing and the outer circumference of the bobbin housing, respectively, by compressing the outer circumference of the bobbin housing onto the inner circumference of the valve housing.

5. A method of assembling a solenoid valve of a variable damping force damper, comprising:
coupling a valve housing to one side of a damper;
accommodating an embedded assembly within the valve housing, the embedded assembly including a variable fluid path component and a solenoid operator;
disposing a bobbin housing such that an inner circumference of the bobbin housing partially overlaps an outer circumference of the valve housing;
adjusting orientation of a power line connected to a bobbin accommodated in the bobbin housing; and
fastening the bobbin housing to the valve housing with the orientation of the power line adjusted.

6. The method according to claim 5 wherein the accommodating an embedded assembly includes threadedly fastening the embedded assembly and the valve housing.

7. The method according to claim 5 wherein the fastening the bobbin housing to the valve housing includes engaging a groove with a protrusion, the groove and the protrusion being formed on the outer circumference of the bobbin housing and the inner circumference of the valve housing, respectively, by compressing the outer circumference of the bobbin housing onto the inner circumference of the valve housing.
